(19) United States
(12) Patent Application Publication
(10) Pub. No.: US 2021/0406276 A1
(43) Pub. Date: Dec. 30, 2021

(54) SYSTEM FOR AUTOMATED DATA LINEAGE AND MOVEMENT DETECTION

(71) Applicant: Bank of America Corporation, Charlotte, NC (US)

(72) Inventor: Suki Ramasamy, Tamil Nadu (IN)

(73) Assignee: Bank of America Corporation, Charlotte, NC (US)

(21) Appl. No.: 16/912,960

(22) Filed: Jun. 26, 2020

(51) Int. Cl. G06F 16/25; G06F 16/23; G06F 21/31; G06F 21/62; G06K 9/62; G06N 20/00

(52) U.S. Cl. CPC G06F 16/254; G06F 16/2358; G06F 21/31; G06N 20/00; G06K 9/6256; G06K 9/6264; G06F 21/6218

(57) ABSTRACT

Systems, computer program products, and methods are described herein for automated data lineage and movement detection. The present invention is configured to generate a training dataset based on the source data, the target data, and the transformation logic; initiate machine learning algorithms on the training dataset to generate a first set of parameters; generate a test dataset based on at least the unseen source data and the transformed unseen source data; predict, using the first set of parameters, the transformation logic used to transform the unseen source data to transformed unseen source data; determine one or more target computing devices based on at least the transformation logic; and initiate a transmission of the transformed unseen source data to the one or more target computing devices.

### FIELD OF THE INVENTION

The present invention embraces a system for automated data lineage and movement detection.

### BACKGROUND

Data lineage provides a look at how data is manipulated via the ETL. Data Lineage is defined as a data lifecycle that includes the data's origins and where it moves over time. The ability to track, manage and view data lineage helps simplify tracking errors back to the data source and it helps debugging the data flow process. By tracking and utilizing the data lineage information within the analytics process, entities are better able to shorten the decision making process, enhance data loss prevention and enable more efficient and cost-effective compliance and auditing. Data movement provides a look at where the data moves during the ETL process. Keeping track of the data lineage and data movement requires a need for a clear understanding of the transformation logic used to transform the data extracted from the source computing device and load the transformed data to the target computing device.

There is a need for a system for automated data lineage and movement detection.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for automated data lineage and movement detection is presented. The system comprising: at least one non-transitory storage device; and at least one processing device coupled to the at least one non-transitory storage device, wherein the at least one processing device is configured to: electronically retrieve a first portion of source data from one or more source computing devices; electronically retrieve a first portion of target data from one or more target computing devices, wherein the first portion of target data comprises the first portion of source data that is transformed using one or more transformation logic; generate a training dataset based on at least the first portion of source data, the first portion of target data, and the one or more transformation logic; initiate one or more machine learning algorithms on the training dataset to generate a first set of parameters; electronically retrieve a second portion of source data from the one or more source computing devices; electronically retrieve a transformed source data, wherein the transformed source data comprises the second portion of source data that has been transformed using the one or more transformation logic; generate a test dataset based on at least the second portion of source data and the second portion of source data that has been transformed using the one or more transformation logic; predict, using the first set of parameters, the one or more transformation logic used to transform the second portion of source data to the transformed source data; determine a first portion of the one or more target computing devices based on at least the one or more transformation logic predicted using the first set of parameters; and initiate a transmission of the transformed source data to the first portion of the one or more target computing devices.

In some embodiments, the at least one processing device is further configured to: determine one or more prediction indices associated with the one or more transformation logic predicted using the first set of parameters; compare the one or more prediction indices with a predetermined prediction threshold; determine at least one of the one or more prediction indices that are greater than the predetermined prediction threshold; determine a first subset of the first portion of source data with the at least one of the one or more prediction indices that are greater than the predetermined prediction threshold; and automatically initiate the transmission of the first subset of the first portion of source data to the first portion of the one or more target computing devices based on at least determining that the first subset of the first portion of source data with the at least one of the one or more prediction indices that are greater than the predetermined prediction threshold.

In some embodiments, the at least one processing device is further configured to: determine at least one of the one or more prediction indices that are lesser than the predetermined prediction threshold; determine a second subset of the first portion of source data with the at least one of the one or more prediction indices that are lesser than the predetermined prediction threshold; and; generate a transmission request to initiate the transmission of the second subset of the first portion of the source data to a second subset of the first portion of the one or more target computing devices based on at least determining that at least one of the one or more prediction indices that are lesser than the predetermined prediction threshold.

In some embodiments, the at least one processing device is further configured to: transmit control signals configured to cause a computing device associated with a user to display the transmission request; electronically receive, via the computing device, an indication authorizing the transmission request; and initiate the transmission of the second subset of the first portion of the source data to the second subset of the first portion of the one or more target computing devices based on at least receiving the indication.

In some embodiments, the at least one processing device is further configured to: transmit control signals configured to cause the computing device of the user to display an authentication request to verify an identity of the user in response to receiving the indication to authorize the transmission request; electronically receive, via the computing device, one or more authentication credentials from the user; validate the one or more authentication credentials received from the user; verify the identity of the user based on at least validating the one or more authentication credentials; and initiate the transmission of the second subset of the first portion of the source data to the second subset of the first portion of the one or more target computing devices based on at least verifying the identity of the user.

In some embodiments, the at least one processing device is further configured to: electronically retrieve a third portion of source data from the one or more source computing devices; electronically retrieve a third portion of target data from the one or more target computing devices, wherein the third portion of target data comprises the third portion of source data that is transformed using the one or more transformation logic; generate a validation dataset based on at least the third portion of source data, the third portion of target data, and the one or more transformation logic used to transform the third portion of source data to third portion of target data; predict, using the first set of parameters, the one or more transformation logic used to transform the third portion of source data to the third portion of target data; electronically receive one or more ground truth values; compare the one or more transformation logic predicted to be used to transform the third portion of source data to the third portion of target data with the one or more ground truth values; and determine a prediction accuracy associated with the first set of parameters.

In some embodiments, the one or more machine learning algorithms are supervised learning algorithms and unsupervised learning algorithms.

In another aspect, a computer program product for automated data lineage and movement detection is presented. The computer program product comprising a non-transitory computer-readable medium comprising code causing a first apparatus to: electronically retrieve a first portion of source data from one or more source computing devices; electronically retrieve a first portion of target data from one or more target computing devices, wherein the first portion of target data comprises the first portion of source data that is transformed using one or more transformation logic; generate a training dataset based on at least the first portion of source data, the first portion of target data, and the one or more transformation logic; initiate one or more machine learning algorithms on the training dataset to generate a first set of parameters; electronically retrieve a second portion of source data from the one or more source computing devices; electronically retrieve a transformed source data, wherein the transformed source data comprises the second portion of source data that has been transformed using the one or more transformation logic; generate an unseen dataset based on at least the second portion of source data and the second portion of source data that has been transformed using the one or more transformation logic; predict, using the first set of parameters, the one or more transformation logic used to transform the second portion of source data to the transformed source data; determine a first portion of the one or more target computing devices based on at least the one or more transformation logic predicted using the first set of parameters; and initiate a transmission of the transformed source data to the first portion of the one or more target computing devices.

In yet another aspect, a method for automated data lineage and movement detection is presented. The method comprising: electronically retrieving a first portion of source data from one or more source computing devices; electronically retrieving a first portion of target data from one or more target computing devices, wherein the first portion of target data comprises the first portion of source data that is transformed using one or more transformation logic; generating a training dataset based on at least the first portion of source data, the first portion of target data, and the one or more transformation logic; initiating one or more machine learning algorithms on the training dataset to generate a first set of parameters; electronically retrieving a second portion of source data from the one or more source computing devices; electronically retrieving a transformed source data, wherein the transformed source data comprises the second portion of source data that has been transformed using the one or more transformation logic; generating an unseen dataset based on at least the second portion of source data and the second portion of source data that has been transformed using the one or more transformation logic; predicting, using the first set of parameters, the one or more transformation logic used to transform the second portion of source data to the transformed source data; determining a first portion of the one or more target computing devices based on at least the one or more transformation logic predicted using the first set of parameters; and initiating a transmission of the transformed source data to the first portion of the one or more target computing devices.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for automated data lineage and movement detection, in accordance with an embodiment of the invention;

FIG. 2 illustrates a process flow for automated data lineage and movement detection, in accordance with an embodiment of the invention; and

FIG. 3 illustrates a platform for automated data lineage and movement detection, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

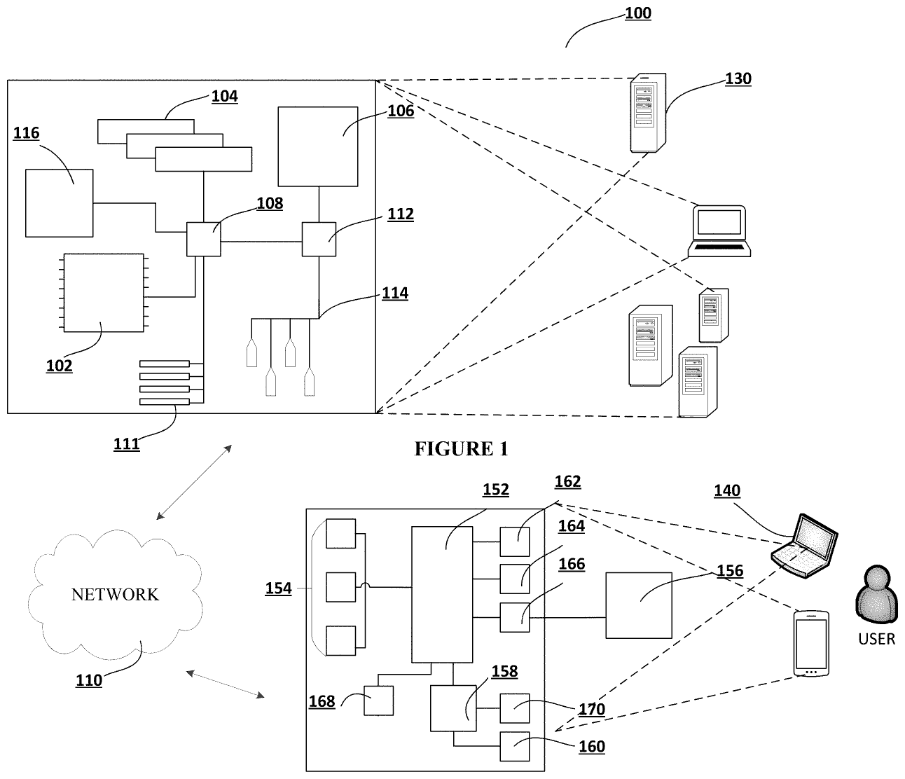

FIG. 1 presents an exemplary block diagram of the system environment for automated data lineage and movement detection 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute resource transfers using one or more applications stored thereon. The one or more applications may be configured to communicate with the system 130, execute a transaction, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, workstations, personal digital assistants, servers, blade servers, mainframes, and other appropriate computers. The user input system 140 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

In some embodiments, the system 130 may be configured to access, via the 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application, and allows memory reuse for better utilization of the memory resources when the data sizes are large.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140, or may also store applications or other information therein. In some embodiments, expansion memory may include instructions to carry out or supplement the processes described above, and may include secure information also. For example, expansion memory may be provided as a security module for user input system 140, and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation—and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

ETL is a type of data integration that refers to the three steps (extract, transform, load) used to blend data from multiple sources. During this process, data is taken (extracted) from a source computing device, converted (transformed) using a transformation logic, and stored (loaded) into a target computing device. In other words, ETL is the general procedure of copying data from one or more source computing devices into one or more target computing devices which represents the data differently from the source computing device or in a different context than the source computing device.

Data lineage provides a look at how data is manipulated via the ETL. Data Lineage is defined as a data lifecycle that includes the data's origins and where it moves over time. The ability to track, manage and view data lineage helps simplify tracking errors back to the data source and it helps debugging the data flow process. By tracking and utilizing the data lineage information within the analytics process, entities are better able to shorten the decision making process, enhance data loss prevention and enable more efficient and cost-effective compliance and auditing. Data movement provides a look at where the data moves during the ETL process. Keeping track of the data lineage and data movement requires a need for a clear understanding of the transformation logic used to transform the data extracted from the source computing device and load the transformed data to the target computing device. Current ETL processes require manual intervention to understand the transformation logic to determine where to move the transformed data after the data undergoes transformation. The present invention provides the functional benefit of using machine learning (ML) and/or artificial intelligence (AI) to automatically predict the transformation logic used to transform the data retrieved from the source computing device to be stored on the target computing device.

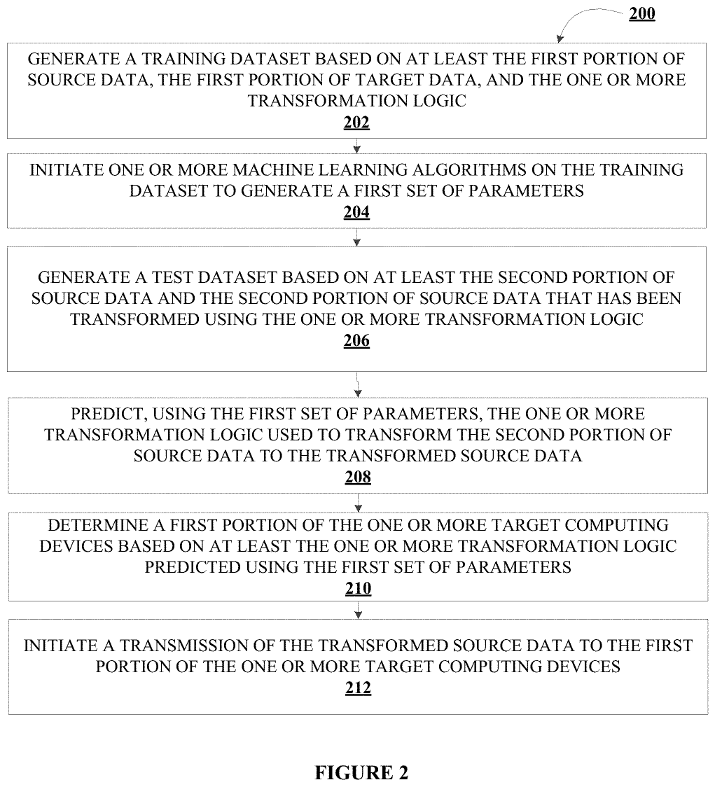

FIG. 2 illustrates a process flow for automated data lineage and movement detection 200, in accordance to an embodiment of the invention. As shown in block 202, the process includes generating a training dataset based on at least the first portion of source data, the first portion of target data, and the one or more transformation logic. In some embodiments, the system may be configured to electronically retrieve a first portion of source data from one or more source computing devices. In this regard, the system may be configured to establish a communication link with the one or more source computing devices. In one aspect, the one or more source computing devices may include one or more databases including, but not limited to, a centralized database, a distributed database, a personal database, an end-user database, a commercial database, a noSQL database, an operational database, a relational database, a cloud database, an object-oriented database, a graph database, and/or the like. Accordingly, the system may be configured to retrieve the first portion of source data from the one or more databases associated with the one or more source computing devices. Similarly, in some embodiments, the system may be configured to electronically retrieve the first portion of target data from one or more target computing devices. In one aspect, the one or more target computing devices may include one or more databases similar to that of the one or more source computing devices.

In some embodiments, the first portion of target data may be first portion of source data that has undergone transformation using one or more transformation logic. In one aspect, the one or more transformation logic allows for expression of semantic properties by appropriate logical formulas. In some embodiments, the transformation logic may include one or more data processing instructions that manipulate data stored in the one or more databases in the source computing devices. In this regard, the transformation logic may include, but is not limited to arithmetic instructions, shifts, logical instructions, comparison instructions, multiply instructions, and/or the like. In some other embodiments, the transformation logic may include one or more mapping instructions for converting data from one format to another. For example, XML data can be transformed from XML data valid to one XML Schema to another XML document valid to a different XML Schema. Other examples include the data transformation from non-XML data to XML data. In yet other embodiments, the transformation logic may be any data manipulation techniques capable of being implemented on source data.

In some embodiments, once the first portion of source data and the first portion of target data are retrieved, the system may be configured to generate the training dataset to train a machine learning model. In some embodiments, the training dataset may be a set of examples used to fit a set of parameters (e.g., weights of connections between neurons in artificial neural networks) of the machine learning model. Training datasets require several example predictor variables to classify or predict a response. The predictor variables are called features and the responses are called labels. Here, the first portion of source data and the first portion of target data are the features of the training dataset, and the transformation logic known to be used to transform the first portion of source data into the portion of target data, are the labels.

Next, as shown in block 204, the process flow includes initiating one or more machine learning algorithms on the training dataset to generate a first set of parameters. In some embodiments, the system may be configured to implement any of the following applicable machine learning algorithms either singly or in combination: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and any other suitable learning style. Each module of the plurality can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) can be used in generating data relevant to the system 130

In one aspect, the system may be configured to initiate the training of the one or more machine learning algorithms using the training dataset. In this regard, the system may be configured to implement an optimization algorithm that searches through a space of possible values for a set of parameters (or weights) that results in good performance on the training dataset. These set of parameters may be used to best map the inputs (the first portion of source data and the first portion of target data) to the outputs (transformation logic). Typically, the training process is iterative, meaning that it progresses step by step with small updates to the set of parameters in each iteration and, in turn, a change in the performance of the machine learning model each iteration. In some embodiments, the first set of parameters may be generated by solving the optimization problem that finds for parameters that result in minimum error or loss when evaluating the source data and the target data.

In some embodiments, the system may be configured to determine a prediction accuracy associated with the first set of parameters. Prediction accuracy is defined as the number of correctly classified patterns to the total number of patterns. It can also be defined as the ratio of sum of true positives (TP) and true negatives (TN) to the total number of trials [sum of TP, false positives (FP), false negatives (FN), and TN]. In this regard, the system may be configured to generate a test dataset. The test dataset provides an unbiased evaluation of a machine learning model fit on the training dataset while tuning the model's set of parameters (e.g., the number of hidden units (layers and layer widths) in a neural network). Test datasets can be used for regularization by early stopping (stopping training when the error on the test dataset increases, as this is a sign of overfitting to the training dataset).

In some embodiments, the system may be configured to electronically retrieve a third portion of source data from the one or more source computing devices. In addition, the system may be configured to electronically retrieve a third portion of target data from the one or more target computing devices. In one aspect, the third portion of target data may be the third portion of source data that is transformed using the one or more transformation logic. To maintain data integrity during the testing process, care is taken to maintain mutual exclusivity between the first portion of source data and third portion of source data. Similarly, care is taken it maintain mutual exclusivity between the first portion of target data and the third portion of target data. In response, the system may be configured to generate the test dataset based on at least the third portion of source data, the third portion of target data, and the one or more transformation logic used to transform the third portion of source data to third portion of target data.

In response to generating the test dataset, the system may be configured to predict, using the first set of parameters, the one or more transformation logic used to transform the third portion of source data to the third portion of target data. The predicted transformation logic is then compared to a set of ground truth values. The ground truth values are typically used to check the results of the machine learning algorithm's accuracy against the predicted classes. By comparing the predicted transformation logic with the set of ground truth values, the system may be configured to determine a prediction accuracy associated with the first set of parameters.

Next, as shown in block 206, the process flow includes generating an unseen dataset based on at least the second portion of source data and the second portion of source data that has been transformed using the one or more transformation logic. In some embodiments, the machine learning model with the first set of parameters are implemented on the unseen dataset to initiate the classification process. Next, as shown in block 208, the process flow includes predicting, using the first set of parameters, the one or more transformation logic used to transform the second portion of source data to the transformed source data. In this way, the first set of parameters may be used to map the second portion of source data and the second portion of target data to one or more transformation logic.

Next, as shown in block 210, the process flow includes determining a first portion of the one or more target computing devices based on at least the one or more transformation logic predicted using the first set of parameters.

Next, as shown in block 212, the process flow includes initiating a transmission of the transformed source data to the first portion of the one or more target computing devices. In some embodiments, the system may be configured to determine one or more prediction indices associated with the one or more transformation logic predicted using the first set of parameters. In some embodiments, the one or more prediction indices may be a probabilistic measure associated with the accuracy of the prediction. In response, the system may be configured to compare the one or more prediction indices with a predetermined prediction threshold. In response, the system may be configured to determine a first subset of the first portion of source data with the at least one of the one or more prediction indices that are greater than the predetermined prediction threshold. In response, the system may be configured to automatically initiate the transmission of the first subset of the first portion of source data to the first portion of the one or more target computing devices based on at least determining that the first subset of the first portion of source data with the at least one of the one or more prediction indices that are greater than the predetermined prediction threshold.

In some embodiments, the system may be configured to determine at least one of the one or more prediction indices that are lesser than the predetermined prediction threshold. In response, the system may be configured to determine a second subset of the first portion of source data with the at least one of the one or more prediction indices that are lesser than the predetermined prediction threshold. In response, the system may be configured to generate a transmission request to initiate the transmission of the second subset of the first portion of the source data to a second subset of the first portion of the one or more target computing devices based on at least determining that at least one of the one or more prediction indices that are lesser than the predetermined prediction threshold.

In some embodiments, the system may be configured to transmit control signals configured to cause a computing device associated with a user to display the transmission request. In response, the system may be configured to electronically receive, via the computing device, an indication authorizing the transmission request. In response, the system may be configured to initiate the transmission of the second subset of the first portion of the source data to the second subset of the first portion of the one or more target computing devices based on at least receiving the indication. In some embodiments, the system may be configured to require authenticating the identity and authorization level of the user. In this regard, the system may be configured to transmit control signals configured to cause the computing device of the user to display an authentication request to verify an identity of the user in response to receiving the indication to authorize the transmission request. In response, the system may be configured to electronically receive, via the computing device, one or more authentication credentials from the user. In response, the system may be configured to validate the one or more authentication credentials received from the user. In response to receiving the authentication credentials, the system may be configured to validate the one or more authentication credentials received from the user. In doing so, the system may be configured to verify the identity of the user and the authorization level of the user. Accordingly, the system may be configured to initiate the transmission of the second subset of the first portion of the source data to the second subset of the first portion of the one or more target computing devices based on at least verifying the identity of the user and the authorization level of the user.

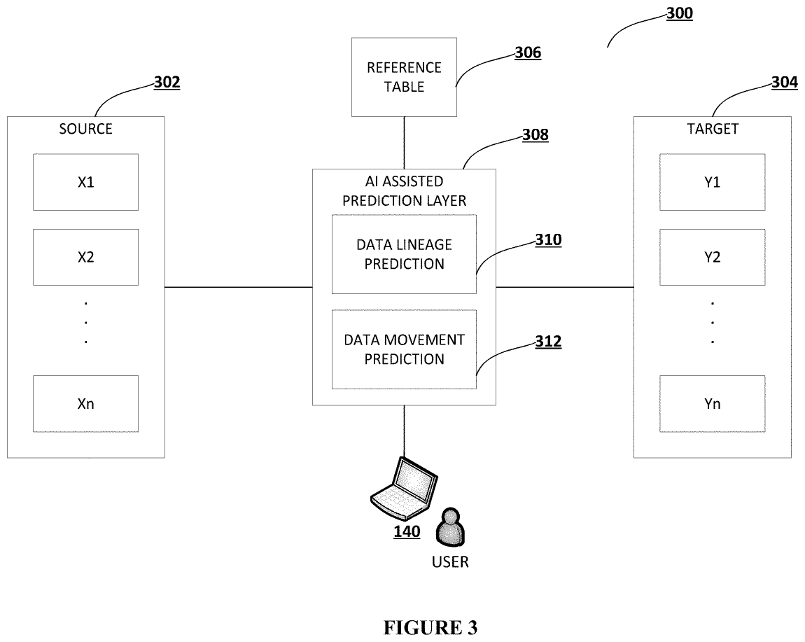

FIG. 3 illustrates a platform for automated data lineage and movement detection 300, in accordance with an embodiment of the invention. As shown in FIG. 3, the platform includes one or more source computing devices (X1, X2, . . . X3) 302, one or more target computing devices (Y1, Y2, . . . Y3) 304, a reference table 306, a user input system 140, and an AI Assisted Prediction Layer 308. In one aspect, the AI Assisted Prediction Layer 308 may include a data lineage prediction component 310 and a data movement prediction component 312. In some embodiments, the reference table may include the transformation logic used to transform the source data. Once transformed, the system may then be configured to determine specific target computing devices to store the transformed data. The AI Assisted Prediction Layer 308 may be used to implement the one or more machine learning algorithms to determine the transformation logic used to transform the source data into the target data. In this regard, the system may be configured to determine, using the data lineage prediction component 310, the origin of the data, i.e., which source computing device the source data is retrieved from, and determine, using the data movement component 312, where the transformed data is moving to, i.e., which target computing device the data is to be transmitted to. Any manual intervention required to initiate the transmission of the transformed data my be authorized by the user using the user input system 140.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for automated data lineage and movement detection, the system comprising:
at least one non-transitory storage device; and
at least one processing device coupled to the at least one non-transitory storage device, wherein the at least one processing device is configured to:
electronically retrieve a first portion of source data from one or more source computing devices;
electronically retrieve a first portion of target data from one or more target computing devices, wherein the first portion of target data comprises the first portion of source data that is transformed using one or more transformation logic;
generate a training dataset based on at least the first portion of source data, the first portion of target data, and the one or more transformation logic;
initiate one or more machine learning algorithms on the training dataset to generate a first set of parameters;
electronically retrieve a second portion of source data from the one or more source computing devices;
electronically retrieve a transformed source data, wherein the transformed source data comprises the second portion of source data that has been transformed using the one or more transformation logic;
generate an unseen dataset based on at least the second portion of source data and the second portion of source data that has been transformed using the one or more transformation logic;
predict, using the first set of parameters, the one or more transformation logic used to transform the second portion of source data to the transformed source data;
determine a first portion of the one or more target computing devices based on at least the one or more transformation logic predicted using the first set of parameters; and
initiate a transmission of the transformed source data to the first portion of the one or more target computing devices.

2. The system of claim 1, wherein the at least one processing device is further configured to:
determine one or more prediction indices associated with the one or more transformation logic predicted using the first set of parameters;
compare the one or more prediction indices with a predetermined prediction threshold;
determine at least one of the one or more prediction indices that are greater than the predetermined prediction threshold;
determine a first subset of the first portion of source data with the at least one of the one or more prediction indices that are greater than the predetermined prediction threshold; and
automatically initiate the transmission of the first subset of the first portion of source data to the first portion of the one or more target computing devices based on at least determining that the first subset of the first portion of source data with the at least one of the one or more prediction indices that are greater than the predetermined prediction threshold.

3. The system of claim 2, wherein the at least one processing device is further configured to:
determine at least one of the one or more prediction indices that are lesser than the predetermined prediction threshold;
determine a second subset of the first portion of source data with the at least one of the one or more prediction indices that are lesser than the predetermined prediction threshold; and
generate a transmission request to initiate the transmission of the second subset of the first portion of the source data to a second subset of the first portion of the one or more target computing devices based on at least determining that at least one of the one or more prediction indices that are lesser than the predetermined prediction threshold.

4. The system of claim 3, wherein the at least one processing device is further configured to:
transmit control signals configured to cause a computing device associated with a user to display the transmission request;
electronically receive, via the computing device, an indication authorizing the transmission request; and
initiate the transmission of the second subset of the first portion of the source data to the second subset of the first portion of the one or more target computing devices based on at least receiving the indication.

5. The system of claim 4, wherein the at least one processing device is further configured to:
transmit control signals configured to cause the computing device of the user to display an authentication request to verify an identity of the user in response to receiving the indication to authorize the transmission request;
electronically receive, via the computing device, one or more authentication credentials from the user;
validate the one or more authentication credentials received from the user;
verify the identity of the user based on at least validating the one or more authentication credentials; and
initiate the transmission of the second subset of the first portion of the source data to the second subset of the first portion of the one or more target computing devices based on at least verifying the identity of the user.

6. The system of claim 1, wherein the at least one processing device is further configured to:
electronically retrieve a third portion of source data from the one or more source computing devices;
electronically retrieve a third portion of target data from the one or more target computing devices, wherein the third portion of target data comprises the third portion of source data that is transformed using the one or more transformation logic;
generate a test dataset based on at least the third portion of source data, the third portion of target data, and the one or more transformation logic used to transform the third portion of source data to third portion of target data;
predict, using the first set of parameters, the one or more transformation logic used to transform the third portion of source data to the third portion of target data;
electronically receive one or more ground truth values;
compare the one or more transformation logic predicted to be used to transform the third portion of source data to the third portion of target data with the one or more ground truth values; and
determine a prediction accuracy associated with the first set of parameters.

7. The system of claim 1, wherein the one or more machine learning algorithms are supervised learning algorithms and unsupervised learning algorithms.

8. A computer program product for automated data lineage and movement detection, the computer program product comprising a non-transitory computer-readable medium comprising code causing a first apparatus to:
electronically retrieve a first portion of source data from one or more source computing devices;
electronically retrieve a first portion of target data from one or more target computing devices, wherein the first portion of target data comprises the first portion of source data that is transformed using one or more transformation logic;
generate a training dataset based on at least the first portion of source data, the first portion of target data, and the one or more transformation logic;
initiate one or more machine learning algorithms on the training dataset to generate a first set of parameters;
electronically retrieve a second portion of source data from the one or more source computing devices;
electronically retrieve a transformed source data, wherein the transformed source data comprises the second portion of source data that has been transformed using the one or more transformation logic;
generate an unseen dataset based on at least the second portion of source data and the second portion of source data that has been transformed using the one or more transformation logic;
predict, using the first set of parameters, the one or more transformation logic used to transform the second portion of source data to the transformed source data;
determine a first portion of the one or more target computing devices based on at least the one or more transformation logic predicted using the first set of parameters; and
initiate a transmission of the transformed source data to the first portion of the one or more target computing devices.

9. The computer program product of claim 8, wherein the first apparatus is further configured to:
determine one or more prediction indices associated with the one or more transformation logic predicted using the first set of parameters;
compare the one or more prediction indices with a predetermined prediction threshold;
determine at least one of the one or more prediction indices that are greater than the predetermined prediction threshold;
determine a first subset of the first portion of source data with the at least one of the one or more prediction indices that are greater than the predetermined prediction threshold; and
automatically initiate the transmission of the first subset of the first portion of source data to the first portion of the one or more target computing devices based on at least determining that the first subset of the first portion of source data with the at least one of the one or more prediction indices that are greater than the predetermined prediction threshold.

10. The computer program product of claim 9, wherein the first apparatus is further configured to:
determine at least one of the one or more prediction indices that are lesser than the predetermined prediction threshold;
determine a second subset of the first portion of source data with the at least one of the one or more prediction indices that are lesser than the predetermined prediction threshold; and
generate a transmission request to initiate the transmission of the second subset of the first portion of the source data to a second subset of the first portion of the one or more target computing devices based on at least determining that at least one of the one or more prediction indices that are lesser than the predetermined prediction threshold.

11. The computer program product of claim 10, wherein the first apparatus is further configured to:
transmit control signals configured to cause a computing device associated with a user to display the transmission request;
electronically receive, via the computing device, an indication authorizing the transmission request; and
initiate the transmission of the second subset of the first portion of the source data to the second subset of the first portion of the one or more target computing devices based on at least receiving the indication.

12. The computer program product of claim 11, wherein the first apparatus is further configured to:
transmit control signals configured to cause the computing device of the user to display an authentication request to verify an identity of the user in response to receiving the indication to authorize the transmission request;
electronically receive, via the computing device, one or more authentication credentials from the user;
validate the one or more authentication credentials received from the user;
verify the identity of the user based on at least validating the one or more authentication credentials; and
initiate the transmission of the second subset of the first portion of the source data to the second subset of the first portion of the one or more target computing devices based on at least verifying the identity of the user.

13. The computer program product of claim 8, wherein the first apparatus is further configured to:
electronically retrieve a third portion of source data from the one or more source computing devices;
electronically retrieve a third portion of target data from the one or more target computing devices, wherein the third portion of target data comprises the third portion of source data that is transformed using the one or more transformation logic;
generate a test dataset based on at least the third portion of source data, the third portion of target data, and the one or more transformation logic used to transform the third portion of source data to third portion of target data;
predict, using the first set of parameters, the one or more transformation logic used to transform the third portion of source data to the third portion of target data;
electronically receive one or more ground truth values;
compare the one or more transformation logic predicted to be used to transform the third portion of source data to the third portion of target data with the one or more ground truth values; and
determine a prediction accuracy associated with the first set of parameters.

14. The computer program product of claim 8, wherein the one or more machine learning algorithms are supervised learning algorithms and unsupervised learning algorithms.

15. A method for automated data lineage and movement detection, the method comprising:
electronically retrieving a first portion of source data from one or more source computing devices;
electronically retrieving a first portion of target data from one or more target computing devices, wherein the first portion of target data comprises the first portion of source data that is transformed using one or more transformation logic;
generating a training dataset based on at least the first portion of source data, the first portion of target data, and the one or more transformation logic;
initiating one or more machine learning algorithms on the training dataset to generate a first set of parameters;
electronically retrieving a second portion of source data from the one or more source computing devices;
electronically retrieving a transformed source data, wherein the transformed source data comprises the second portion of source data that has been transformed using the one or more transformation logic;
generating an unseen dataset based on at least the second portion of source data and the second portion of source data that has been transformed using the one or more transformation logic;
predicting, using the first set of parameters, the one or more transformation logic used to transform the second portion of source data to the transformed source data;
determining a first portion of the one or more target computing devices based on at least the one or more transformation logic predicted using the first set of parameters; and
initiating a transmission of the transformed source data to the first portion of the one or more target computing devices.

16. The method of claim 15, wherein the method further comprises:
determining one or more prediction indices associated with the one or more transformation logic predicted using the first set of parameters;
comparing the one or more prediction indices with a predetermined prediction threshold;
determining at least one of the one or more prediction indices that are greater than the predetermined prediction threshold;
determining a first subset of the first portion of source data with the at least one of the one or more prediction indices that are greater than the predetermined prediction threshold; and
automatically initiating the transmission of the first subset of the first portion of source data to the first portion of the one or more target computing devices based on at least determining that the first subset of the first portion of source data with the at least one of the one or more prediction indices that are greater than the predetermined prediction threshold.

17. The method of claim 16, wherein the method further comprises:
determining at least one of the one or more prediction indices that are lesser than the predetermined prediction threshold;
determining a second subset of the first portion of source data with the at least one of the one or more prediction indices that are lesser than the predetermined prediction threshold; and
generating a transmission request to initiate the transmission of the second subset of the first portion of the source data to a second subset of the first portion of the one or more target computing devices based on at least determining that at least one of the one or more prediction indices that are lesser than the predetermined prediction threshold.

18. The method of claim 17, wherein the method further comprises:
transmitting control signals configured to cause a computing device associated with a user to display the transmission request;
electronically receiving, via the computing device, an indication authorizing the transmission request; and
initiating the transmission of the second subset of the first portion of the source data to the second subset of the first portion of the one or more target computing devices based on at least receiving the indication.

19. The method of claim 18, wherein the method further comprises:
transmitting control signals configured to cause the computing device of the user to display an authentication request to verify an identity of the user in response to receiving the indication to authorize the transmission request;
electronically receiving, via the computing device, one or more authentication credentials from the user;
validating the one or more authentication credentials received from the user;
verifying the identity of the user based on at least validating the one or more authentication credentials; and
initiating the transmission of the second subset of the first portion of the source data to the second subset of the first portion of the one or more target computing devices based on at least verifying the identity of the user.

20. The method of claim 15, wherein the method further comprises:
electronically retrieving a third portion of source data from the one or more source computing devices;
electronically retrieving a third portion of target data from the one or more target computing devices, wherein the third portion of target data comprises the third portion of source data that is transformed using the one or more transformation logic;
generating a test dataset based on at least the third portion of source data, the third portion of target data, and the one or more transformation logic used to transform the third portion of source data to third portion of target data;
predicting, using the first set of parameters, the one or more transformation logic used to transform the third portion of source data to the third portion of target data;
electronically receiving one or more ground truth values;
comparing the one or more transformation logic predicted to be used to transform the third portion of source data to the third portion of target data with the one or more ground truth values; and
determining a prediction accuracy associated with the first set of parameters.
